(19) United States
(12) Patent Application Publication
(10) Pub. No.: US 2017/0247912 A1
(43) Pub. Date: Aug. 31, 2017

(54) ELECTRICAL LOCK

(71) Applicant: NIDEC SANKYO CORPORATION, Suwa-gun (JP)

(72) Inventor: Masaaki ANDO, Suwa-gun (JP)

(21) Appl. No.: 15/440,681

(22) Filed: Feb. 23, 2017

(30) Foreign Application Priority Data
Feb. 25, 2016 (JP) 2016-033943

(51) Int. Cl. E05B 47/00; E05B 17/20; E05B 55/00

(52) U.S. Cl. CPC E05B 47/0012; E05B 55/00; E05B 17/2069; E05B 2047/002; E05B 2047/0073

(57) ABSTRACT

An electrical lock may include a main body case; a dead bolt being movable between a locked position and an unlocked; a dead bolt moving element structured to move the dead bolt; a drive source structured to move the dead bolt moving element; a power transmission mechanism structured to transmit power of the drive source to the dead bolt moving element; a manual-handling component, which is placed at an outdoor side of the door, structured to manually move the dead bolt, being at the locked position, to the unlocked position; a manual unlocking mechanism to which the manual-handling component is connected; and a restriction member structured to restrict a motion of the manual-handling component, the restriction member being formed in, or fixed to the dead bolt moving element.

### CROSS REFERENCE TO RELATED APPLICATION

The present invention claims priority under 35 U.S.C. §119 to Japanese Application No. 2016-033943 filed Feb. 25, 2016, the entire content of which is incorporated herein by reference.

### FIELD OF THE INVENTION

The present invention relates to an electrical lock that is installed on a door for a use.

### BACKGROUND

Conventionally, a motor-driven electrical lock being installed on a door for a use is known (for example, refer to Patent Document 1). An electrical lock described in Patent Document 1 is provided with a dead bolt, a dead cam for moving the dead bolt, and a motor for turning the dead cam. Then, the dead cam includes a sector gear that engages with a drive gear connected to the motor, and a drive arm. Meanwhile, in the dead bolt, there is formed a follower cutout with which the drive arm engages, so that the dead bolt moves in accordance with a movement of the drive arm. In the dead cam, there is formed a clutch hole to which a thumb-turn placed at an indoor side and a cylinder placed at an outdoor side are connected. A key hole is provided inside the cylinder.

In the case of the electrical lock described in Patent Document 1; for example, when an authentication by means of a predetermined authentication system finishes, the motor drives to turn the dead cam and move the dead bolt, so as to unlock the electrical lock in a locked condition. Then, if there is caused a displacement in a relative position between a strike hole formed in a door frame, and the dead bolt, for example, owing to an effect of a change across the ages and the like, a friction resistance between the strike hole and the dead bolt becomes great so that the dead bolt may not move by chance even though the motor drives, in the electrical lock under a locked condition. In such a case; usually, a key is inserted into a key hole of the cylinder from an outdoor side, and the dead cam is manually turned by making use of the key inserted into the key hole to unlock the electrical lock under the locked condition. Meanwhile, from an indoor side, the dead cam is manually turned by making use of the thumb-turn to unlock the electrical lock under the locked condition.

### Patent Document

Patent Document 1; Japanese Unexamined Patent Application Publication No. 2012-251422

Inside the cylinder, a key hole having a complicated shape is formed, and moreover it is necessary to have a key to be inserted into the key hole so that the cylinder is expensive in comparison to a thumb-turn. Therefore, in the case of an electrical lock, such as the electrical lock described in Patent Document 1, where the cylinder is provided as a means for moving the dead bolt from the outdoor side when it becomes impossible to move the dead bolt by use of power of the motor, the electrical lock becomes expensive. Incidentally, if a thumb-turn is provided at the outdoor side instead of the cylinder, the dead bolt can be moved from the outdoor side when it becomes impossible to move the dead bolt by use of power of the motor. Nevertheless, if the thumb-turn is simply provided at the outdoor side of the door, inconveniently anybody can unlock the electrical lock at any time, and therefore the electrical lock does not serve a function as a locking device.

### SUMMARY

Then, it at least an embodiment of the present invention provices an electrical lock whose manufacturing cost can be reduced, even though a dead bolt, which cannot be moved by use of power of a drive source, can be moved from an outdoor side.

In order to bring a solution for the subject described above; an electrical lock according to the present invention is an electrical lock being installed on a door for a use, the electrical lock including: a main body case; a dead bolt being movable between a locked position where the dead bolt protrudes out of the main body case, and an unlocked position where the dead bolt is housed in the main body case; a dead bolt moving element that is engaged with the dead bolt, and moves the dead bolt; a drive source for moving the dead bolt moving element; a power transmission mechanism for transmitting power of the drive source to the dead bolt moving element; a manual-handling component, which is placed at an outdoor side of the door, for manually moving the dead bolt, being at the locked position, to the unlocked position; a manual unlocking mechanism to which the manual-handling component is connected; and a restriction member for restricting a motion of the manual-handling component, the restriction member being formed in, or fixed to the dead bolt moving element; wherein, in a situation where the dead bolt moving element moves the dead bolt from the locked position to the unlocked position by use of the power of the drive source, the dead bolt moving element moves in a sequential order; from a standby position; by way of an unlocking start position where the dead bolt moving element makes contact with the dead bolt, and a travel of the dead bolt toward the unlocked position begins; to an unlocking finish position where the dead bolt arrives at the unlocked position; and the manual unlocking mechanism includes: a second restriction member, to which the manual-handling component is connected, for restricting a motion of the manual-handling component, by way of contacting the restriction member; and a releasing member for moving the dead bolt moving element, at least from the unlocking start position to the unlocking finish position, while being engaged with the dead bolt moving element, and the releasing member being moved by a motion of the manual-handling component; and at a time when the manual-handling component is operated in the situation where the dead bolt moving element is placed at the standby position, the restriction member and the second restriction member contact with each other to restrict the working range of the manual-handling component, in order to make the dead bolt immobile; and in a situation where the dead bolt moving element is placed at the unlocking start position, a restriction on the working range of the manual-handling component is removed in such a way that the dead bolt can move to the unlocking position.

In the case of the electrical lock according to the present invention; in a situation where the dead bolt moving element moves the dead bolt from the locked position to the unlocked position by use of the power of the drive source, the dead bolt moving element moves in a sequential order; from the standby position; by way of the unlocking start position where the dead bolt moving element makes contact with the dead bolt, and the travel of the dead bolt toward the unlocked position begins; to the unlocking finish position where the dead bolt arrives at the unlocked position. Then, according to at least an embodiment of the present invention; when the manual-handling component is operated in the situation where the dead bolt moving element is placed at the standby position, the restriction member and the second restriction member contact with each other to restrict the working range of the manual-handling component, in order to make the dead bolt immobile. Therefore, according to at least an embodiment of the present invention; even though the manual-handling component is a thumb-turn, for example, operating the manual-handling component cannot move the dead bolt placed at the locked position, unless an authentication by means of an authentication system finishes and the drive source gets activated. Accordingly, the electrical lock of at least an embodiment of the present invention plays a role of a lock, even if the manual-handling component is a thumb-turn.

Moreover, according to at least an embodiment of the present invention; in a situation where the dead bolt moving element moves the dead bolt from the locked position to the unlocked position by use of the power of the drive source, the dead bolt moving element moves in a sequential order; from a standby position; by way of the unlocking start position where the dead bolt moving element makes contact with the dead bolt, and the travel of the dead bolt toward the unlocked position begins; to the unlocking finish position where the dead bolt arrives at the unlocked position; and therefore, even in a situation where using the power of the drive source cannot move the dead bolt placed at the locked position, the dead bolt moving element moves to the unlocking start position if the authentication by means of the authentication system finishes and the drive source gets activated. Moreover, according to at least an embodiment of the present invention; in a situation where the dead bolt moving element is placed at the unlocking start position, the restriction on the working range of the manual-handling component is removed in such a way that the dead bolt can move to the unlocking position; and therefore, the dead bolt can be moved to the unlocking position, by operating the manual-handling component.

In this way, the electrical lock according to at least an embodiment of the present invention plays a role of a lock, even though the manual-handling component placed at an outdoor side of the door is a thumb-turn. Moreover, according to at least an embodiment of the present invention, even in a situation where using the power of the drive source cannot move the dead bolt placed at the locked position, the dead bolt can be moved to the unlocked position, by way of operating the manual-handling component placed at the outdoor side of the door. Therefore, according to at least an embodiment of the present invention, a manufacturing cost for the electrical lock can be reduced even though it is possible to move the dead bolt from the outdoor side, wherein the dead bolt cannot be moved by use of the power of the drive source.

In the electrical lock according to at least an embodiment of the present invention, it is preferable that the electrical lock is provided with a second manual-handling component placed at an indoor side of the door for manually moving the dead bolt placed at the locked position to the unlocked position; the second manual-handling component is connected to the releasing member; and the second restriction member is formed separately from the releasing member, and independent from the releasing member, and the second restriction member moves the releasing member, by way of operating the manual-handling component. According to the configuration in this way; even though the working range of the manual-handling component is restricted, the dead bolt, which the power of the drive source cannot move, can be moved by the second manual-handling component (for example, a thumb-turn) placed at the indoor side of the door. Therefore, the dead bolt, which the power of the drive source cannot move, can easily be moved by the second manual-handling component placed at the indoor side.

In at least an embodiment of the present invention, for example; the manual unlocking mechanism is provided with; a first lever member in which a first engaging hole is formed at one end, wherein a part of the manual-handling component being inserted into, and engaged with the first engaging hole, the first lever member being supported by the main body case so as to be rotatable, and rotating in connection with a rotating motion of the manual-handling component; and a second lever member in which a second engaging hole is formed at one end, wherein a part of the second manual-handling component being inserted into, and engaged with the second engaging hole, the second lever member being supported by the main body case so as to be rotatable, and rotating in connection with a rotating motion of the second manual-handling component; and the other end side of the first lever member is engaged with the second restriction member, and meanwhile, the manual-handling component and the second restriction member are connected with each other by the intermediary of the first lever member; and the other end side of the second lever member is engaged with the releasing member, and meanwhile, the second manual-handling component and the releasing member are connected with each other by the intermediary of the second lever member.

In at least an embodiment of the present invention; it is preferable that the manual unlocking mechanism is provided with; a first biasing member for biasing the releasing member in order to return the second manual-handling component to an original position predetermined; and a second biasing member for biasing the second restriction member in order to return the manual-handling component to an original position predetermined; and the releasing member is formed separately from the dead bolt moving element, and independent from the dead bolt moving element; and by way of operating the manual-handling component in a situation where the restriction on the working range is removed, or by way of operating the second manual-handling component, the releasing member is engaged with the dead bolt moving element so as to move the dead bolt moving element, at least from the unlocking start position to the unlocking finish position. According to the configuration in this way; it becomes possible to make the manual-handling component, the second manual-handling component, the releasing member, and the second restriction member immobile, at a time when the dead bolt moving element is moved by use of the power of the drive source. Therefore, at a time of moving the dead bolt between the unlocked position and the locked position by use of the power of the drive source, a load of the drive source can be reduced.

In at least an embodiment of the present invention; it is preferable that the dead bolt moving element is supported by the main body case, in such a way as to be rotatable; the power transmission mechanism is provided with; a gear component that is coaxially located with the dead bolt moving element, and placed so as to overlap with the dead bolt moving element, in a rotating shaft direction of the dead bolt moving element; and a gear biasing component for biasing the gear component; a first engaging part is formed in, or fixed to the dead bolt moving element, in such a way as to be engaged with the gear component; a second engaging part is formed in, or fixed to the gear component in such a way as to be engaged with the first engaging part; the gear biasing component biases the gear component in such a way that the first engaging part and the second engaging part are engaged with one another so that the dead bolt moving element and the gear component rotate together; the releasing member is provided with a cam part for dissolving engagement of the first engaging part and the second engaging part; the gear component is provided with a cam follower part for engagement of the cam part; and at a time of operating the manual-handling component in a situation where the restriction on the working range is removed, or at a time of operating the second manual-handling component, the cam part is engaged with the cam follower part so as to dissolve the engagement of the first engaging part and the second engaging part, before the releasing member is engaged with the dead bolt moving element so as to rotate the dead bolt moving element. According to the configuration in this way; the dead bolt moving element and the power transmission mechanism can get separated, before rotating the dead bolt moving element. Therefore, even in the case where the power transmission mechanism includes a worm gear set, it becomes possible to rotate the dead bolt moving element by operating the manual-handling component and the second manual-handling component.

As described above, according to at least an embodiment of the present invention; it becomes possible to reduce a manufacturing cost of an electrical lock, even though a dead bolt, which cannot be moved by use of power of a drive source, can be moved from an outdoor side.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an elevation view for explanation of a configuration of an electrical lock according to an embodiment of the present invention.

FIG. 2 is a side view for explanation of the configuration of the electrical lock, in a view along arrows “E-E” of FIG. 1.

FIG. 3(A) and FIG. 3(B) include drawings for explanation of a locking motion and an unlocking motion by use of a motor, in the electrical lock shown in FIG. 1.

FIG. 4(A) and FIG. 4(B) include drawings for explanation of a locking motion and an unlocking motion by use of the motor, in the electrical lock shown in FIG. 1.

FIG. 5 is a drawing for explanation of a locking motion and an unlocking motion by use of the motor, in the electrical lock shown in FIG. 1.

FIG. 6(A) and FIG. 6(B) include drawings for explanation of an unlocking motion by use of a second manual-handling component, in the electrical lock shown in FIG. 1.

FIG. 7(A) and FIG. 7(B) include drawings for explanation of an unlocking motion by use of the second manual-handling component, in the electrical lock shown in FIG. 1.

FIG. 8(A) is a side view drawing for explaining a situation of the electrical lock shown in FIG. 6(A), and meanwhile FIG. 8(B) is a side view drawing for explaining a situation of the electrical lock, the situation being in status between FIG. 6(A) and FIG. 6(B).

FIG. 9(A) is a side view drawing for explaining a situation of the electrical lock shown in FIG. 6(B), and meanwhile FIG. 9(B) is a side view drawing for explaining a situation of the electrical lock shown in FIG. 7(A).

FIG. 10(A) is a magnified view drawing of a section “F” in FIG. 8(A), and meanwhile FIG. 10(B) is a magnified view drawing of a section “G” in FIG. 8(B).

FIG. 11(A) and FIG. 11(B) include drawings for explanation of an unlocking motion by use of a manual-handling component, in the electrical lock shown in FIG. 1.

FIG. 12(A) and FIG. 12(B) include drawings for explanation of an unlocking motion by use of the manual-handling component, in the electrical lock shown in FIG. 1.

FIG. 13 is a drawing for explanation of an unlocking motion by use of the manual-handling component, in the electrical lock shown in FIG. 1.

### DETAILED DESCRIPTION

An embodiment of the present invention is explained below with reference to the accompanying drawings.

### (General Structure of the Electrical Lock)

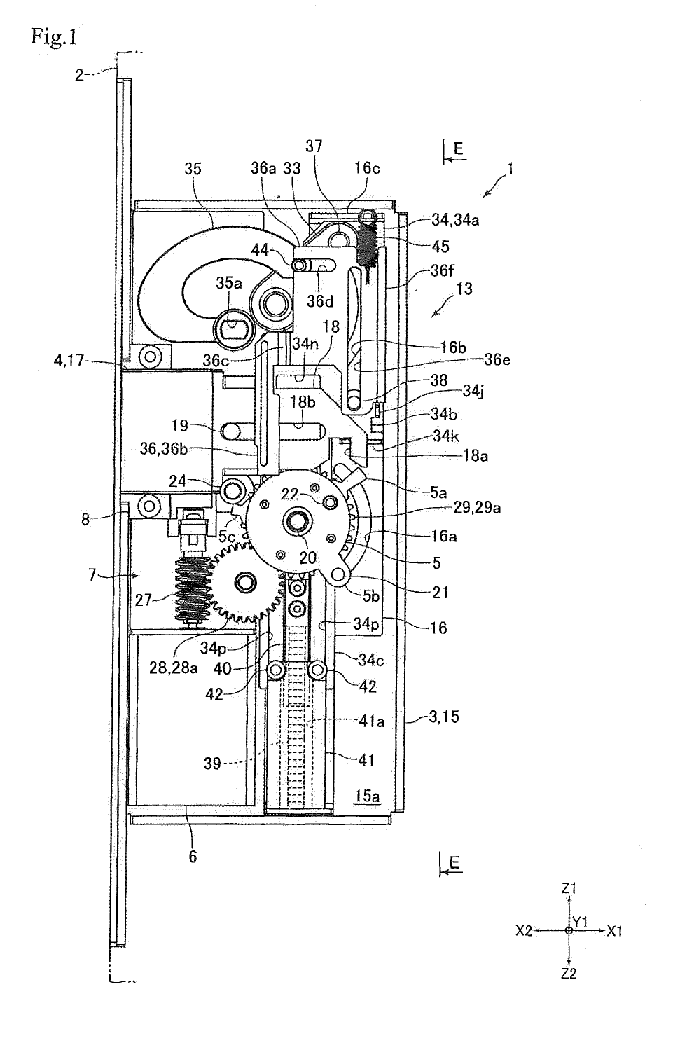

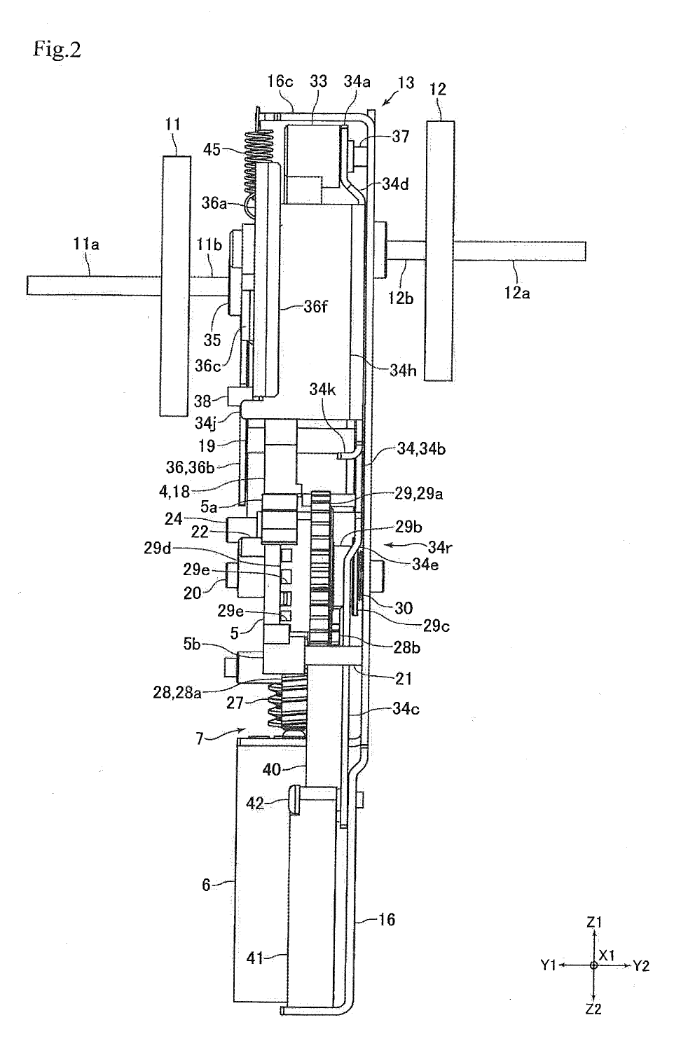

FIG. 1 is an elevation view for explanation of a configuration of an electrical lock 1 according to an embodiment of the present invention. FIG. 2 is a side view for explanation of the configuration of the electrical lock 1, in a view along arrows “E-E” of FIG. 1.

The electrical lock 1 of at least an embodiment of the present invention is a device for locking a door 2 (a hinged door) in order to prevent the door 2 from getting opened, wherein the electrical lock 1 is installed on the door 2 for a use. Specifically to describe, the electrical lock 1 is built in the door 2 for a use. The electrical lock 1 is supplied with electric power by way of a cable that is introduced into an internal part of the door 2 from a door frame (not illustrated) to which the door 2 is fit so as to be openable. As another possibility, the electrical lock 1 is supplied with electric power from a battery being built in the door 2. As still another possibility, the electrical lock 1 is supplied with electric power, by way of contact-free electric power transmission.

The electrical lock 1 is provided with a main body case 3, a dead bolt 4 that goes out and come in from/to the main body case 3, a dead bolt moving element 5 that engages with the dead bolt 4 and moves the dead bolt 4, a motor 6 that is a drive source for moving the dead bolt moving element 5, a power transmission mechanism 7 for transmitting power of the motor 6 to the dead bolt moving element 5, and a guide element 8 for guiding the dead bolt 4.

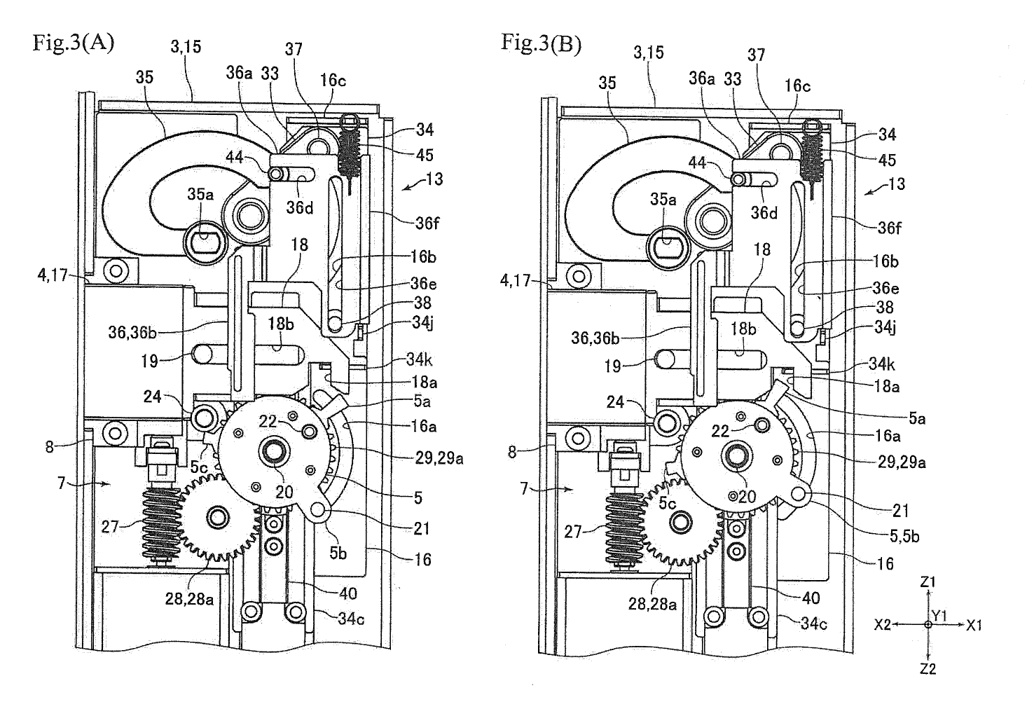

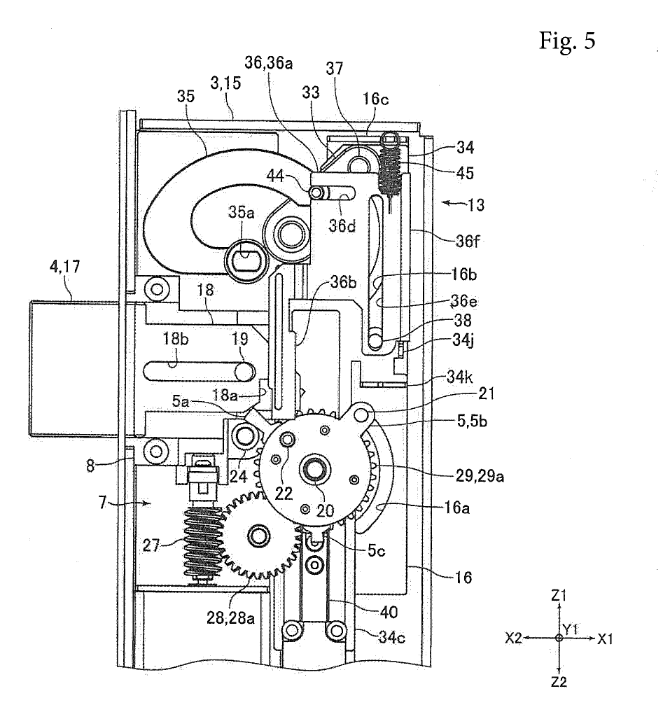

The dead bolt 4 is able to move between a locked position (a position where FIG. 5 shows) at which the dead bolt 4 protrudes from the main body case 3 (specifically to describe, a part of the dead bolt 4 protrudes), and an unlocked position (a position where FIG. 3(A)-3(B) shows) at which the dead bolt 4 is housed in the main body case 3 (specifically to describe, an entire part of the dead bolt 4 is housed); wherein the dead bolt moving element 5 moves the dead bolt 4 within a range between the locked position and the unlocked position. In the meantime, the dead bolt moving element 5 linearly moves between the locked position and the unlocked position, while being guided by the guide element 8.

Meanwhile, the electrical lock 1 is provided with; a thumb-turn 11 as a manual-handling component that is placed at an outdoor side of the door 2 for manually moving the dead bolt 4, being at the locked position, to the unlocked position; a thumb-turn 12 as a second manual-handling component that is placed at an indoor side of the door 2 for manually moving the dead bolt 4, being at the locked position, to the unlocked position; and a manual unlocking mechanism 13 to which the thumb-turn 11 and the thumb-turn 12 are connected. As shown in FIG. 2, the thumb-turn 11 includes a finger grip 11a, and a shaft part 11b stretching from the finger grip 11a. In the same manner, the thumb-turn 12 also includes a finger grip 12a, and a shaft part 12b stretching from the finger grip 12a. Incidentally, in FIG. 1, illustrations of the thumb-turn 11 and the thumb-turn 12 are omitted.

In an explanation described below; in FIG. 1, FIG. 2, and the like; an X1-direction side represents a “right” side, an X2-direction side is a “left” side, a Y1-direction side means a “front” side, and a Y2-direction side is a “rear” side, a Z1-direction side means an “upper” side, and a Z2-direction side is a “lower” side. Moreover, a clockwise direction in FIG. 1 is dealt with as a “clockwise direction”, and a counterclockwise direction in FIG. 1 is dealt with as a “counterclockwise direction”. In the present embodiment, the “front” side is an outdoor side of the door 2, and the “rear” side is an indoor side of the door 2.

The main body case 3 is formed as a box, which is almost like a flat rectangular-parallelepiped having a small thickness dimension in a front-rear direction; wherein, the main body case 3 is provided with a case member 15 formed as a box, which has an open part at a front surface side, and being almost a flat rectangular-parallelepiped; and a flat-plate cover member (not illustrated) being almost rectangular for covering the open part of the case member 15. At a front surface of a rear surface part 15a of the case member 15, there is fixed an installation plate 16 for installing the dead bolt 4, the dead bolt moving element 5, the motor 6, the power transmission mechanism 7, the guide element 8, the manual unlocking mechanism 13, and the like.

The dead bolt 4 is configured with a dead bolt main part 17 configuring a left side part of the dead bolt 4; and a support plate 18 that supports the dead bolt main part 17, and configures a right side part of the dead bolt 4. The dead bolt main part 17 is formed so as to be a rectangular-parallelepiped as a block, and fixed to a left end surface of the support plate 18. When the dead bolt 4 is placed at the locked position, the dead bolt main part 17 protrudes to a left side out of a left side surface of the main body case 3, and meanwhile the support plate 18 is housed in the main body case 3. In the meantime, when the dead bolt 4 is placed at the unlocked position, the dead bolt main part 17 and the support plate 18 are housed in the main body case 3.

At a right end side of the support plate 18, there is formed a concave part 18a that is hollowed upward from a lower end surface of the support plate 18. The concave part 18a is formed in such a way as to completely pass through the support plate 18 in a front-rear direction. Moreover, the concave part 18a is shaped so as to be almost rectangular in a view from the front-rear direction. A lower end of the concave part 18a (namely, an open end of the concave part 18a) is chamfered off. Then, the concave part 18a is engaged with a first arm part 5a, to be described later, which configures a part of the dead bolt moving element 5.

At a center position of the support plate 18 in a vertical direction, there is formed a guide hole 18b shaped like an elongated hole, having a right-left direction as an longitudinal direction, wherein the guide hole 18b is formed so as to completely pass through in a front-rear direction. Then, a guide pin 19, fixed to the installation plate 16, is inserted through the guide hole 18b. Meanwhile, the guide element 8 is fixed to the installation plate 16. The guide element 8 is formed so as to be almost like a square pipe having an open end at each of right and left ends in order to guide the dead bolt main part 17 in a right-left direction. Then, the dead bolt 4 moves in the right-left direction, while being guided by the guide element 8 and the guide pin 19. Incidentally, an illustration of a front side part of the guide element 8 is omitted in FIG. 1 and the like.

The dead bolt moving element 5 is shaped so as to be almost like a disk, while being placed in such a way that a thickness direction of the dead bolt moving element 5 coincides with a front-rear direction. The dead bolt moving element 5 is supported by a fixing shaft 20, in such a way as to be rotatable. Meanwhile, the fixing shaft 20 is fixed to the main body case 3, in such a way that a shaft direction of the fixing shaft 20 coincides with the front-rear direction. In other words, the dead bolt moving element 5 is supported by the main body case 3, by the intermediary of the fixing shaft 20, in such a way as to be rotatable, wherein the dead bolt moving element 5 is able to rotate, in relation to a rotating shaft direction that coincides with the front-rear direction. Moreover, the dead bolt moving element 5 is placed at a lower side in relation to the dead bolt 4.

In the dead bolt moving element 5, there are formed a first arm part 5a and a second arm part 5b that are protruding outward in a radial direction of the dead bolt moving element 5. The first arm part 5a is formed in such a way as to have a shape with which the first arm part 5a can engage with the concave part 18a of the dead bolt 4, and the first arm part 5a is placed at a position in such a way as to become able to engage with the concave part 18a. The second arm part 5b is formed at a position that is displaced about 90 degrees in a clockwise direction in relation to the first arm part 5a. In a rotation range of the dead bolt moving element 5, the first arm part 5a is placed at an upper end side of the dead bolt moving element 5, and meanwhile the second arm part 5b is placed at a right end side of the dead bolt moving element 5.

Moreover, in the dead bolt moving element 5, there is formed a stopper part 5c protruding outward in a radial direction of the dead bolt moving element 5. The stopper part 5c is formed at a position that is displaced about 120 degrees in a counterclockwise direction in relation to the first arm part 5a. Moreover, the stopper part 5c is formed in such a way as to have a shape with which the stopper part 5c can collide with a stopper pin 24 that is fixed to the main body case 3. The stopper pin 24 is fixed to the main body case 3, in such a way that a shaft direction of the stopper pin 24 coincides with a front-rear direction. Moreover, the stopper pin 24 is placed at a left-hand side of the dead bolt moving element 5. In the present embodiment, a rotation range of the dead bolt moving element 5 in a clockwise direction is restricted by the stopper pin 24 and the stopper part 5c, and meanwhile, a rotation range of the dead bolt moving element 5 in a counterclockwise direction is restricted by the stopper pin 24 and the first arm part 5a.

The dead bolt moving element 5 is provided with a guide pin 21 that is fixed to a top end part of the second arm part 5b (an outside end part of the dead bolt moving element 5 in a radial direction). The guide pin 21 is fixed to the second arm part 5b in such a way as to protrude rearward from the second arm part 5b. In the installation plate 16, there is formed a guide hole 16a, being shaped arc-like, in such a way as to completely pass through the installation plate 16, wherein a rear end part of the guide pin 21 is inserted through the guide hole 16a.

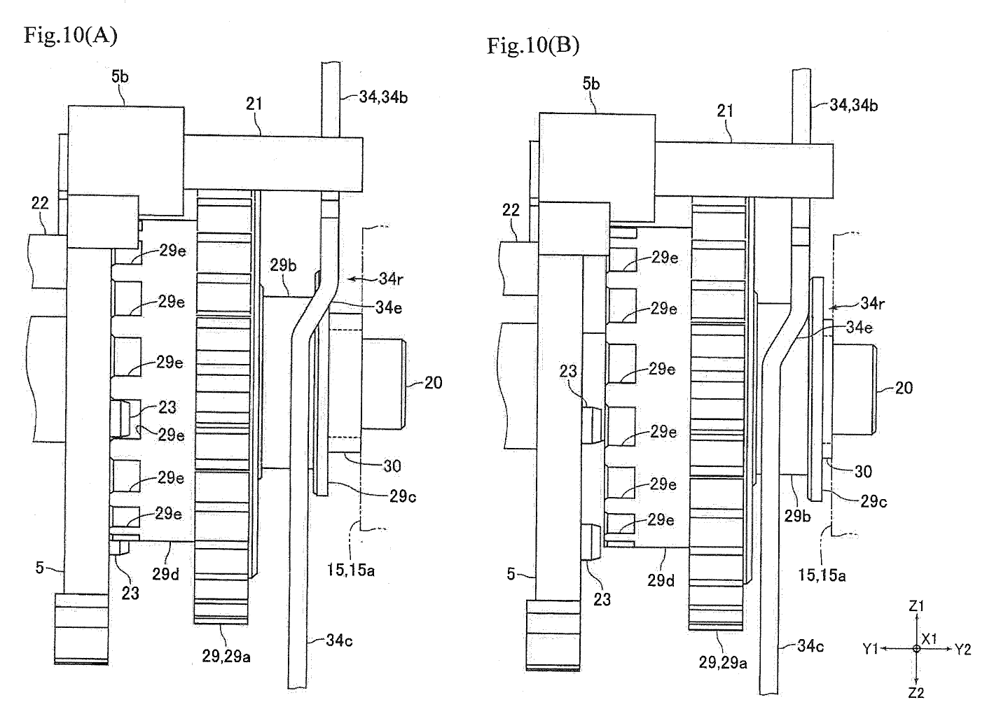

Moreover, to the dead bolt moving element 5, there are fixed a restriction pin 22 as a restriction member for restricting a motion of the thumb-turn 11, and engaging pins 23 (refer to FIG. 10(A) and FIG. 10(B)) as a first engaging part for engagement with a gear member 29, to be described later, included in the power transmission mechanism 7. The restriction pin 22 is fixed to the dead bolt moving element 5 in such a way as to protrude frontward from a front surface of the dead bolt moving element 5. Moreover, the restriction pin 22 is placed at a position that meets the first arm part 5a in a radial direction of the dead bolt moving element 5. In the meantime, the engaging pins 23 are fixed to the dead bolt moving element 5 in such a way as to protrude rearward from a rear surface of the dead bolt moving element 5. In the present embodiment, four engaging pins 23 are placed at a pitch of 90 degrees.

### (Configuration and Motion of the Power Transmission Mechanism)

FIG. 3(A)-3(B) through FIG. 5 are drawings for explanation of a locking motion and an unlocking motion by use of the motor 6, in the electrical lock 1 shown in FIG. 1.

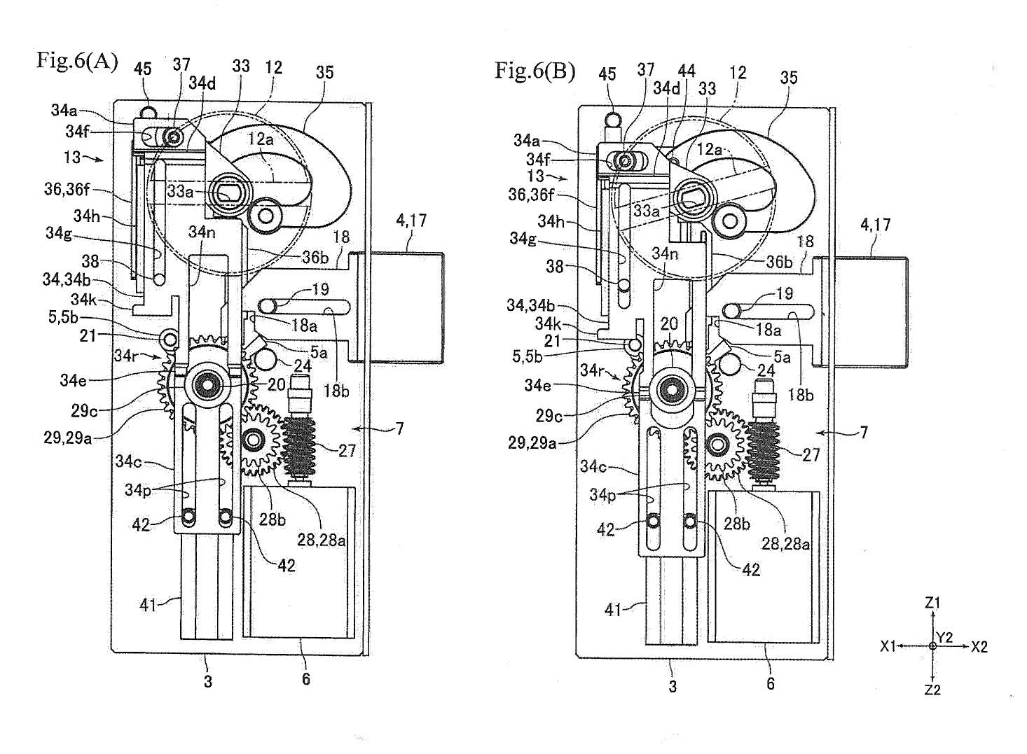

The motor 6 is fixed to the installation plate 16 in such a way that an output shaft of the motor 6 protrudes upward. The motor 6 and the power transmission mechanism 7 are placed at a lower side in relation to the dead bolt 4. The power transmission mechanism 7 is provided with a worm gear (worm) 27 fixed to the output shaft of the motor 6, and two gear components 28 and 29. The gear component 28 is supported so as to be rotatable with a fixing shaft, which is fixed to the main body case 3; wherein the gear component 28 is able to rotate, in relation to a rotating shaft direction that coincides with a front-rear direction. In the gear component 28, there are formed a herical gear (worm wheel) 28a that engages with the worm gear 27, and a spur gear 28b (refer to FIG. 6(A)-6(B) and the like). Meanwhile, the herical gear 28a and the spur gear 28b are placed coaxially.

The gear component 29 is supported by the fixing shaft 20 in such a way that the gear component 29 can move in a front-rear direction. Moreover, the gear component 29 is supported by the fixing shaft 20 so as to be rotatable, while being coaxially located with the dead bolt moving element 5. In other words, the gear component 29 is placed so as to overlap with the dead bolt moving element 5, in the front-rear direction as the rotating shaft direction of the dead bolt moving element 5. Specifically to describe, the gear component 29 is placed at a rear side of the dead bolt moving element 5.

On the gear component 29, there is formed a spur gear 29a for engaging with the spur gear 28b. Moreover, in the gear component 29, there is formed a columnar boss 29b protruding rearward from a rear surface of the spur gear 29a; and a flange part 29c is formed at a rear end of the boss 29b. The flange part 29c is formed so as to have an annular shape of extending outward in a radial direction of the boss 29b from the rear end of the boss 29b. Between the rear surface part 15a of the case member 15 and the gear component 29, there is placed a compression coil spring 30 as a gear biasing component for biasing the gear component 29 toward a front side. At a rear surface of the boss 29b, there is formed a concave part (not illustrated), in which a front end part of the compression coil spring 30 is placed, so as to be hollowed toward a front side.

Moreover, in the gear component 29, there is formed a columnar boss 29d protruding frontward from a front surface of the spur gear 29a; and at a front end side of the boss 29d, there are formed a plurality of concave parts 29e so as to be hollowed toward a rear side from a front end surface of the boss 29d, wherein the concave parts 29e are positioned along an outer circumferential surface. The concave parts 29e are so formed as to lead to the outer circumferential surface of the boss 29d, while being formed at constant intervals in a circumferential direction of the boss 29d. Moreover, the concave parts 29e are so formed as to have a semi-circular shape in a view from a front side.

As described above, the gear component 29 is biased toward a front side by the compression coil spring 30, and meanwhile the front end surface of the boss 29d contacts with a rear surface of the dead bolt moving element 5. Under the situation (refer to FIG. 10(A)), the engaging pins 23 are located in the concave parts 29e. In other words, the engaging pins 23 and the concave parts 29e engage with one another so that power from the gear component 29 can be transmitted to the dead bolt moving element 5. In this way, the compression coil spring 30 biases the gear component 29 in such a way that the engaging pins 23 and the concave parts 29e engage with one another so that the dead bolt moving element 5 and the gear component 29 rotate together. The concave parts 29e in the present embodiment are a second engaging part for engagement with the engaging pins 23 as the first engaging part. Incidentally, the gear component 29 may be biased by any spring element other than the compression coil spring 30.

When the dead bolt 4 is at the unlocked position so that the electrical lock 1 is in an unlocked condition, the first arm part 5a of the dead bolt moving element 5 is placed at a right-hand side in relation to a right side surface of the concave part 18a of the dead bolt 4, as shown in FIG. 3(A). At the time, the stopper part 5c of the dead bolt moving element 5 is in touch with the stopper pin 24 from a clockwise direction. Under the situation, if the motor 6 gets activated to rotate the dead bolt moving element 5 by a certain angle in a counterclockwise direction by use of power of the motor 6, the first arm part 5a makes contact with a left side surface of the concave part 18a, as shown in FIG. 3(B).

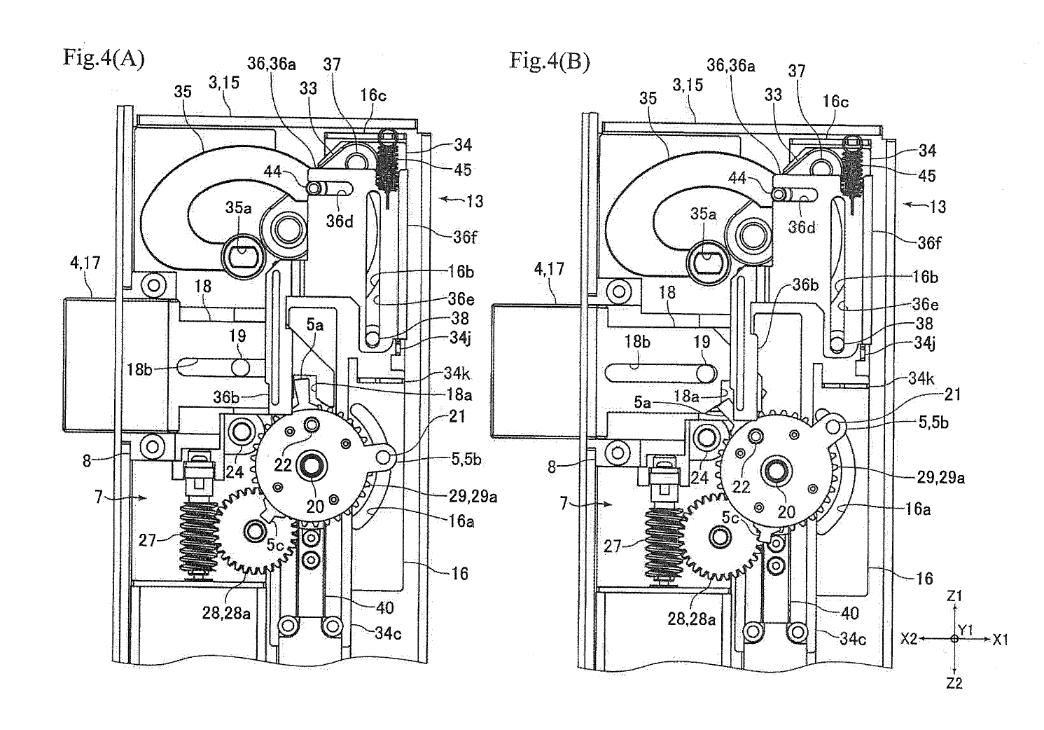

At the time when the first arm part 5a makes contact with the left side surface of the concave part 18a, a travel of the dead bolt 4 toward the locked position gets started. Then, subsequently if the dead bolt moving element 5 further rotates in the counterclockwise direction by use of the power of the motor 6, the dead bolt 4 being pushed by the first arm part 5a is pushed out to the locked position, as shown in FIG. 4(A) and FIG. 4(B), in order to put the electrical lock 1 into a locked condition. Then, even after the dead bolt 4 has reached the locked position, the dead bolt moving element 5 still further rotates a little more in the counterclockwise direction until the first arm part 5a contacts with the stopper pin 24 from a counterclockwise side, and then the dead bolt moving element 5 finally stops at a position shown in FIG. 5.

Moreover, at a time when the dead bolt 4 is placed at the locked position, and the electrical lock 1 is in the locked condition, the first arm part 5a is placed at a left-hand side in relation to the left side surface of the concave part 18a, as shown in FIG. 5. At the time, the first arm part 5a is in touch with the stopper pin 24 from the counterclockwise side. Under the situation, if the motor 6 gets activated to rotate the dead bolt moving element 5 by a certain angle in a clockwise direction by use of power of the motor 6, the first arm part 5a makes contact with the right side surface of the concave part 18a.

At the time when the first arm part 5a makes contact with the right side surface of the concave part 18a, a travel of the dead bolt 4 toward the unlocked position gets started. Then, subsequently if the dead bolt moving element 5 further rotates in the clockwise direction by use of the power of the motor 6, the dead bolt 4 being pushed by the first arm part 5a is pushed out to the unlocked position, in order to put the electrical lock 1 into an unlocked condition. Then, even after the dead bolt 4 has reached the unlocked position, the dead bolt moving element 5 still further rotates a little more in the clockwise direction until the stopper part 5c contacts with the stopper pin 24 from a clockwise side, and then the dead bolt moving element 5 finally stops at a position shown in FIG. 3(A).

In this way, while the dead bolt moving element 5 moves the dead bolt 4 from the unlocked position to the locked position by use of the power of the motor 6, the dead bolt 4 moves (the the dead bolt moving element 5 rotates) in a sequential order; from a standby position at an unlocked side, shown in FIG. 3(A); by way of a locking start position where the dead bolt moving element 5 makes contact with the dead bolt 4, and a travel of the dead bolt 4 toward the locked position begins, as shown in FIG. 3(B); by way of a locking finish position where the dead bolt 4 arrives at the locked position, as shown in FIG. 4(B); to a standby position at a locked side, shown in FIG. 5. In the meantime, while the dead bolt moving element 5 moves the dead bolt 4 from the locked position to the unlocked position by use of the power of the motor 6, the dead bolt 4 moves (the dead bolt moving element 5 rotates) in a sequential order; from the standby position at the locked side, shown in FIG. 5; by way of an unlocking start position where the dead bolt moving element 5 makes contact with the dead bolt 4, and a travel of the dead bolt 4 toward the unlocked position begins; by way of an unlocking finish position where the dead bolt 4 arrives at the unlocked position; to the standby position at the unlocked side, shown in FIG. 3(A).

Incidentally, each of both right and left sides of the concave part 18a is provided with a plunger. One plunger of the two plungers exerts a biasing force between the first arm part 5a at the time when the dead bolt moving element 5 is placed at the standby position at the locked side and the dead bolt 4 placed at the locked position, in such a way as to bias the dead bolt 4 toward a left-hand side. On the other hand, the other plunger exerts a biasing force between the first arm part 5a at the time when the dead bolt moving element 5 is placed at the standby position at the unlocked side and the dead bolt 4 placed at the unlocked position in such a way as to bias the dead bolt 4 toward a right-hand side. Therefore, it is possible to avoid a looseness of the dead bolt 4 placed at the locked position, as well as a looseness of the dead bolt 4 placed at the unlocked position.

Moreover, in the present embodiment; for example, by use of a magnet for detection, fixed to the dead bolt moving element 5, and a Hall element fixed to the main body case 3, it is detected that the dead bolt moving element 5 is placed at the standby position at the locked side, and the dead bolt moving element 5 is placed at the standby position at the unlocked side.

### (Configuration and Motion of the Manual Unlocking Mechanism)

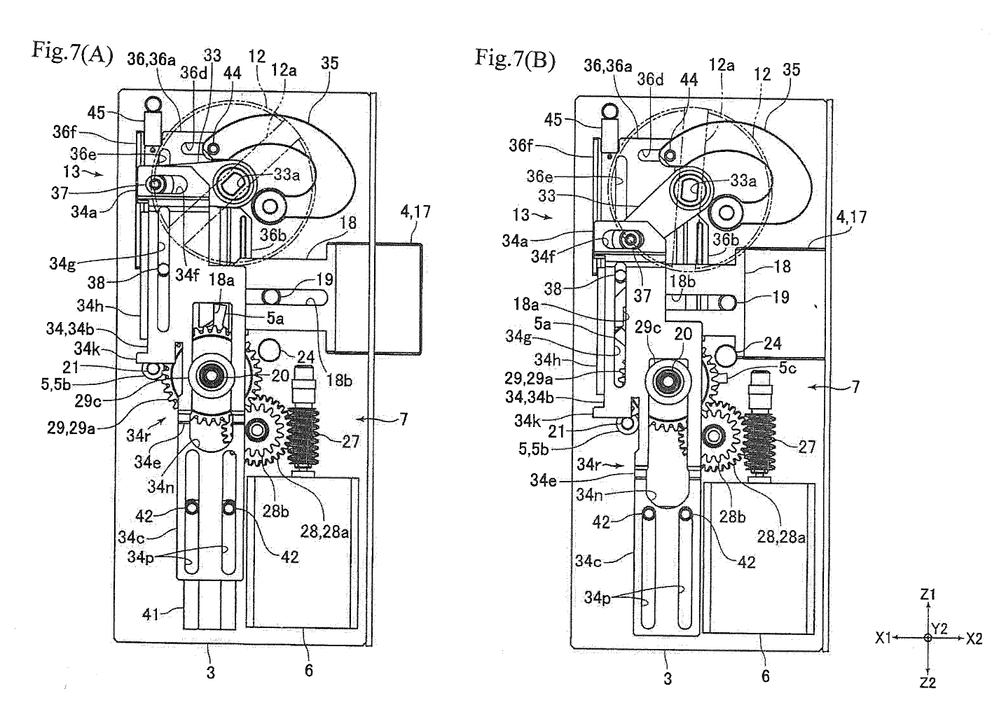

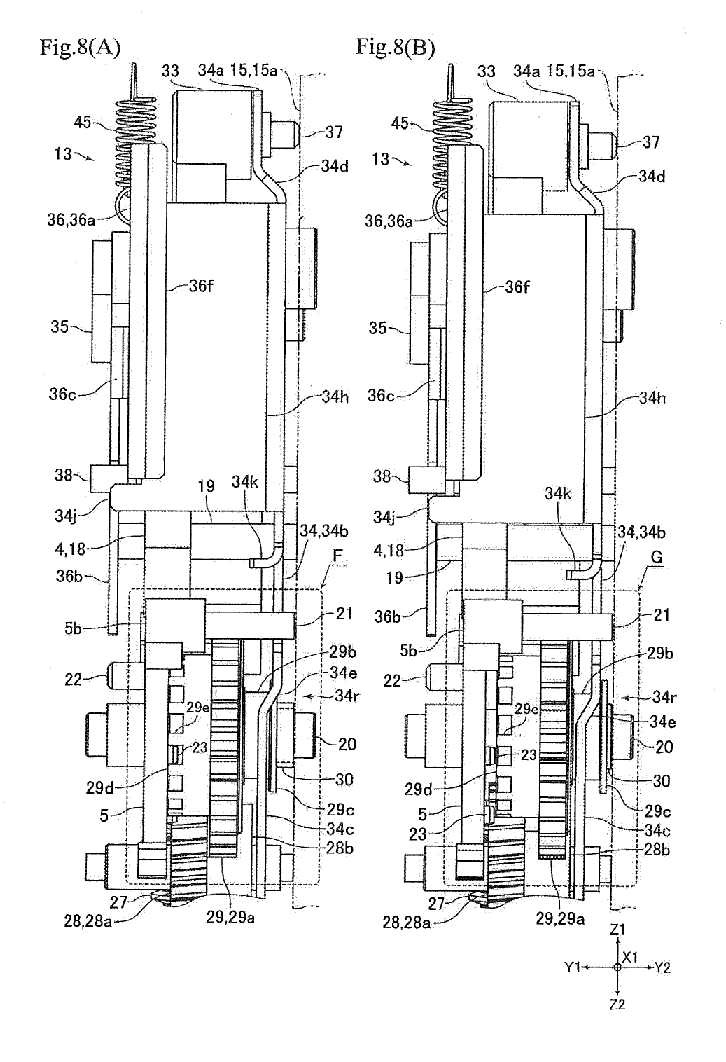

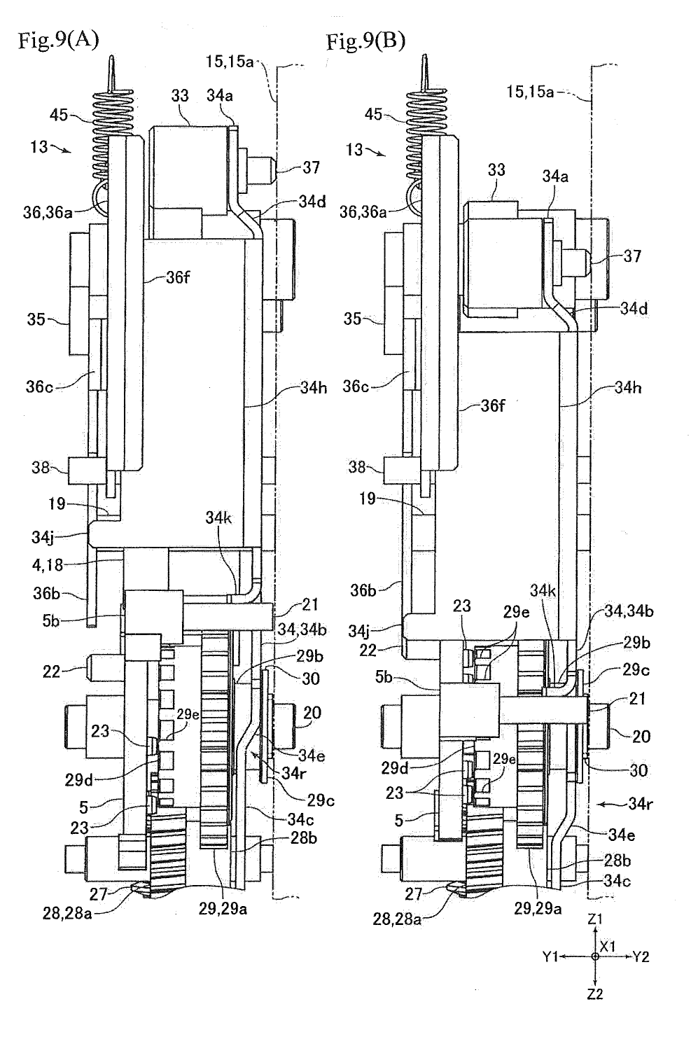

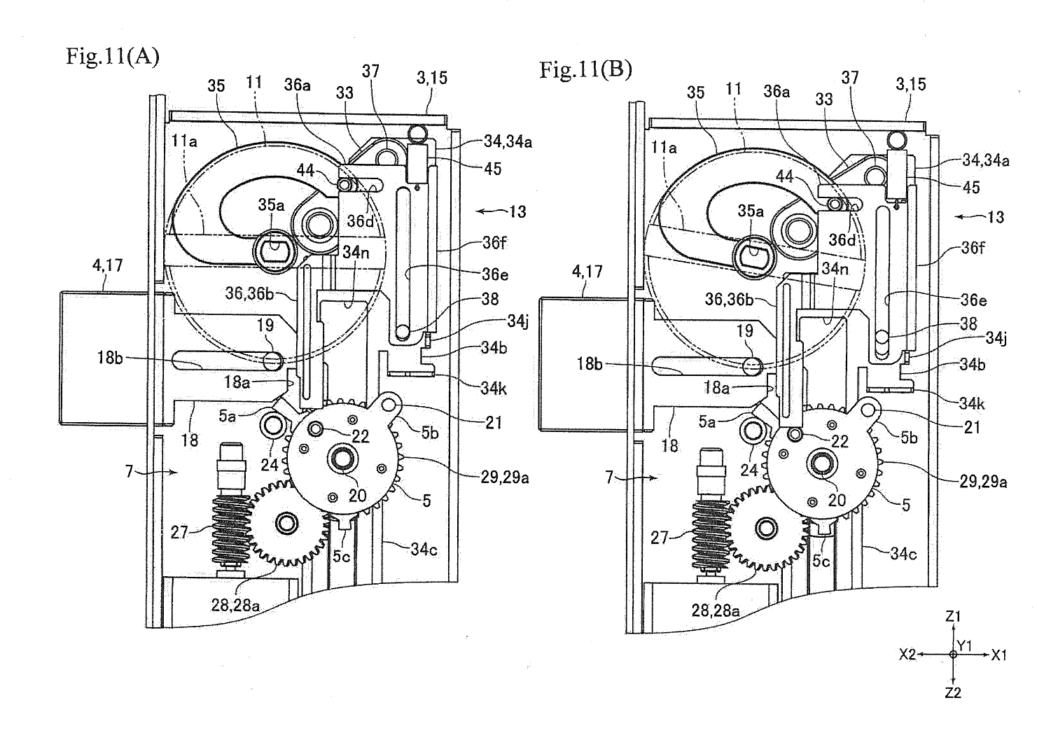

FIG. 6(A), FIG. 6(B), FIG. 7(A) and FIG. 7(B) are drawings for explanation of an unlocking motion by use of the thumb-turn 12 in the electrical lock 1 shown in FIG. 1. FIG. 8(A) is a side view drawing for explaining a situation of the electrical lock 1 shown in FIG. 6(A), and meanwhile FIG. 8(B) is a side view drawing for explaining a situation of the electrical lock 1, the situation being in status between FIG. 6(A) and FIG. 6(B). FIG. 9(A) is a side view drawing for explaining a situation of the electrical lock 1 shown in FIG. 6(B), and meanwhile FIG. 9(B) is a side view drawing for explaining a situation of the electrical lock 1 shown in FIG. 7(A). FIG. 10(A) is a magnified view drawing of a section “F” in FIG. 8(A), and meanwhile FIG. 10(B) is a magnified view drawing of a section “G” in FIG. 8(B). FIG. 11(A) through FIG. 13(B) are drawings for explanation of an unlocking motion by use of the thumb-turn 11 in the electrical lock 1 shown in FIG. 1.

The manual unlocking mechanism 13 are provided with; a lever member 33 in which an engaging hole 33a is formed at one end, wherein the shaft part 12b of the thumb-turn 12 being inserted into, and engaged with the engaging hole 33a; a slide member 34 with which the other end side of the lever member 33 is engaged, wherein the slide member 34 being able to vertically move (slid-able); a lever member 35 in which an engaging hole 35a is formed at one end, wherein the shaft part 11b of the thumb-turn 11 being inserted into, and engaged with the engaging hole 35a; and a slide member 36 with which the other end of the lever member 35 is engaged, wherein the slide member 36 being able to vertically move (slid-able).

Being supported by the main body case 3 so as to be rotatable, the lever member 33 rotates in connection with a rotating motion of the thumb-turn 12. Meanwhile, being supported by the main body case 3 so as to be rotatable, the lever member 35 rotates in connection with a rotating motion of the thumb-turn 11. In the present embodiment, the engaging hole 35a is a first engaging hole into which a part of the thumb-turn 11, as the manual-handling component, is inserted so as to be engaged with, and meanwhile the engaging hole 33a is a second engaging hole into which a part of the thumb-turn 12, as the second manual-handling component, is inserted so as to be engaged with. Moreover, in the present embodiment, the lever member 35 is a first lever member, and meanwhile the lever member 33 is a second lever member.

The lever member 33 is so shaped as to be linear. The lever member 33 is supported by the main body case 3 so as to be rotatable, as described above. Specifically to describe; one end side of the lever member 33, at which the shaft part 12b of the thumb-turn 12 is inserted, is supported by the main body case 3 so as to be rotatable, in such a way that the lever member 33 is able to rotate, in relation to a rotating shaft direction that coincides with a front-rear direction. The one end side of the lever member 33 is placed at an upper side in relation to the dead bolt 4.

The lever member 33 is provided with a guide pin 37 that is fixed at the other end side of the lever member 33. The other end side of the lever member 33, to which the guide pin 37 is fixed, is placed at a right-hand side in relation to the one side of the lever member 33. The guide pin 37 is fixed to the lever member 33 in such a way as to protrude rearward. A rear end part of the guide pin 37 is inserted through a guide hole 16b, being shaped arc-like in the installation plate 16 (refer to FIG. 1 and the like). The guide hole 16b is formed in such a way as to completely pass through the installation plate 16.

The slide member 34 is formed separately from the dead bolt moving element 5, and independent from the dead bolt moving element 5. The slide member 34 is formed by way of bending a vertically elongated metal plate into a predetermined shape, and the slide member 34 includes three planar sections 34a through 34c that are individually perpendicular to a front-rear direction. The planar section 34a is placed at an upper side position in relation to the planar section 34b, the upper side position being at a front side in relation to the planar section 34b. Meanwhile, the planar section 34c is placed at a lower side position in relation to the planar section 34b, the lower side position being at a front side in relation to the planar section 34b. A lower end of the planar section 34a and a part of an upper end of the planar section 34b are connected with each other by use of a planar sloped section 34d that is sloped in relation to the front-rear direction in a view from a right-left direction. Apart of a lower end of the planar section 34b and an upper end of the planar section 34c are connected with each other by use of a planar sloped section 34e that is sloped in relation to the front-rear direction in a view from the right-left direction.

In the planar section 34a, there is formed a slide hole 34f through which the guide pin 37 is inserted. The slide hole 34f is so formed as to completely pass through the planar section 34a in a front-rear direction. Meanwhile, the slide hole 34f is shaped as an elongated hole having a longitudinal direction in a right-left direction. The guide pin 37 is capable of relative displacement along the slide hole 34f in the right-left direction in relation to the slide member 34. Meanwhile, the slide member 34 slides in a vertical direction while being pushed by the guide pin 37 that is inserted through the guide hole 16b and also inserted through the slide hole 34f. In this way, the other end side of the lever member 33, to which the guide pin 37 is fixed, is engaged with the slide member 34. Moreover, as described above, the shaft part 12b of the thumb-turn 12 is engaged with the one end of the lever member 33. In other words, the thumb-turn 12 and the slide member 34 are connected with each other by the intermediary of the lever member 33.

At a right end side of the planar section 34b, there is formed an elongated guide hole 34g that is vertically elongated. The guide hole 34g is formed below the slide hole 34f. The guide hole 34g is so formed as to completely pass through the slide member 34 in a front-rear direction. A guide pin 38 fixed to the installation plate 16 is inserted through the guide hole 34g. The guide pin 38 is fixed to the installation plate 16 in such a way as to protrude frontward from the installation plate 16. The slide member 34 slides in a vertical direction, while being guided by the guide pin 38 inserted through the guide hole 34g.

At a right end of the planar section 34b, there is formed a planar bent part 34h that is bent toward a front side. The bent part 34h is formed so as to be planar and perpendicular to a right-left direction. Moreover, the bent part 34h is formed at a right-hand side of the guide hole 34g. At a lower end side of the bent part 34h, there is formed a protrusion 34j protruding toward a front side. Meanwhile, at a lower side of the guide hole 34g and the bent part 34h of the planar section 34b, there is formed a planar bent part 34k that is bent toward a front direction. The bent part 34k is formed so as to be planar and perpendicular to a vertical direction. The bent part 34k is placed at a position above the guide pin 21.

At a left-hand side of the guide hole 34g and the bent part 34k, there is formed a pass-through hole 34n through which the boss 29b of the gear component 29 is inserted. The pass-through hole 34n is so formed as to completely pass through the slide member 34 in a front-rear direction, and so formed as to be vertically elongated. Moreover, the pass-through hole 34n is formed across an area including a lower end side part of the planar section 34b, the sloped section 34e, and an upper end side part of the planar section 34c. A width of the pass-through hole 34n (a width in the right-left direction) is smaller than a diameter of the flange part 29c of the gear component 29.

To the planar section 34c, a spring retainer part 40 is fixed, in order to retain an upper end side of the compression coil spring 39 (refer to FIG. 1). The spring retainer part 40 is fixed below the pass-through hole 34n and fixed to a front surface of the planar section 34c. The spring retainer part 40 is vertically elongated and formed so as to be almost like a flat rectangular-parallelepiped. At a bottom side of the spring retainer part 40, there is formed a concave part that is hollowed upward; and an upper end part of the compression coil spring 39 is inserted into the concave part. Meanwhile, a lower end part of the compression coil spring 39 makes a contact with a lower end side of the installation plate 16.

The compression coil spring 39 biases the slide member 34 upward. At a time when the slide member 34, biased owing to a biasing force of the compression coil spring 39, is placed at an upper-limit position, the thumb-turn 12 is located at an original position illustrated with a two-dotted dashed line in FIG. 6(A). The compression coil spring 39 of the present embodiment is a first biasing member for biasing the slide member 34 in order to return the thumb-turn 12 to the original position predetermined. Incidentally, the slide member 34 may be biased by any spring element other than the compression coil spring 39.

To a lower end side of the installation plate 16, there is fixed a guide member 41 for vertically guiding the spring retainer part 40 that slides together with the slide member 34. The guide member 41 is fixed to the installation plate 16 by use of screws 42. In the guide member 41, there is formed a guide groove 41a (refer to FIG. 1) being hollowed from a rear side of the guide groove 41a toward a front side thereof, wherein the guide groove 41a having opening sections at both upper and lower ends. When the slide member 34 is lifted so as to be located at the upper-limit position, a lower end side part of the spring retainer part 40 is placed inside the guide groove 41a. Meanwhile, the compression coil spring 39 is placed in the guide groove 41a. Incidentally, in the planar section 34c, there are formed pass-through holes 34p for prevention against collision with the screws 42. The pass-through holes 34p are shaped as elongated holes being vertically elongated, while being formed at two locations having a space between the two locations in a right-left direction.

When the slide member 34 is located at the upper-limit position, the boss 29b of the gear component 29 is placed at a lower end part of the pass-through hole 34n (refer to FIG. 6(A)). Moreover, at the time, a front surface of the planar section 34b is located at a rear side in relation to a front surface of the flange part 29c of the boss 29b, and a rear surface of the planar section 34c is located at a front side in relation to a front surface of the flange part 29c; in such a way that the slide member 34 has no contact with the flange part 29c (refer to FIG. 6A) and FIG. 8(A)). Under the situation, if the_slide member 34 moves downward, a rear surface of the sloped section 34e and a rear surface of the planar section 34b make a contact with the front surface of the flange part 29c in a sequential order (refer to FIG. 6(B), FIG. 7(A) and FIG. 7(B), FIG. 8(B), and FIG. 9(A) and FIG. 9(B)) so that the gear component 29 moves rearward against the biasing force of the compression coil spring 30.

Then, if the gear component 29 moves rearward, the engaging pins 23 are disengaged from the concave parts 29e of the gear component 29, as shown in FIG. 10(B) and the like, so that the dead bolt moving element 5 becomes capable of relative rotation in relation to the gear component 29. In the present embodiment, a cam part 34r for dissolving engagement of the concave parts 29e and the engaging pins 23 is configured by the lower end side part of the planar section 34b and the sloped section 34e. Meanwhile, the flange part 29c in the present embodiment works as a cam follower part for engagement of the cam part 34r. Incidentally, even though the gear component 29 moves rearward, the spur gear 28b and the spur gear 29a are engaged with each other until the engagement of the concave parts 29e and the engaging pins 23 is dissolved.

In a situation where the dead bolt 4 is at a locked position and the electrical lock 1 is in a locked condition, it is possible to move the dead bolt 4 from an indoor side in order to put the electrical lock 1 into an unlocked condition, by way of turning the thumb-turn 12. In a situation where the dead bolt 4 is at the locked position, and the dead bolt moving element 5 is at a standby position of a locked side, and the slide member 34 is placed at the upper-limit position, and the thumb-turn 12 is at the original position; the bent part 34k, being distant from the guide pin 21, is located at a position above the guide pin 21, as shown in FIG. 6(A) and FIG. 8(A).

Turning the thumb-turn 12 under the situation (specifically to describe, turning the thumb-turn 12 in a counterclockwise direction in FIG. 6(A)-6(B) and FIG. 7(A)-7(B)) moves the slide member 34 downward in such a way that; at first, the cam part 34r makes a contact with the flange part 29c so as to move the gear component 29 rearward against the biasing force of the compression coil spring 30, so that the engaging pins 23 are disengaged from the concave parts 29e of the gear component 29 (refer to FIG. 8(B)). Then, further turning the thumb-turn 12 for moving the slide member 34 downward makes the bent part 34k contact with the guide pin 21, as shown in FIG. 6(B), FIG. 7(A)-7(B), and FIG. 9(A)-9(B), and then the guide pin 21 is pushed down from an upper side by the bent part 34k so that the dead bolt moving element 5 rotates so as to move the dead bolt 4 from the locked position to the unlocked position. Under the situation, the gear component 29 is in a stop state. In other words, the power transmission mechanism 7 and the motor 6 are not in operation.

In this way, if the thumb-turn 12 is operated (in other words, by way of turning the thumb-turn 12) in a situation where the dead bolt 4 is at a locked position, the cam part 34r engages with the flange part 29c in such a way as to dissolve the engagement of the concave parts 29e and the engaging pins 23, before the slide member 34 engages with the guide pin 21 of the dead bolt moving element 5 in order to rotate the dead bolt moving element 5. In the meantime, if the thumb-turn 12 is operated in the situation where the dead bolt 4 is at the locked position, the slide member 34 engages with the guide pin 21 of the dead bolt moving element 5 in order to move the dead bolt moving element 5, in such a way that the dead bolt 4 placed at the locked position is moved to the unlocked position.

The lever member 35 is so formed as to be curved, being almost C-shaped in a view from a front-rear direction. The lever member 35 is supported by the main body case 3 so as to be rotatable, as described above. Specifically to describe, one end side of the lever member 35, at which the shaft part llb of the thumb-turn 11 is inserted, is supported by the main body case 3 so as to be rotatable, in such a way that the lever member 33 is able to rotate, in relation to a rotating shaft direction that coincides with a front-rear direction. The one end side of the lever member 35 is placed at an upper side in relation to the dead bolt 4. In the meantime, the one end side of the lever member 35 is placed at an obliquely lower left position in relation to the one end side of the lever member 33. The lever member 35 is provided with a guide pin 44 that is fixed at the other end side of the lever member 35. The guide pin 44 is fixed to the lever member 35 in such a way as to protrude frontward.

The slide member 36 is formed separately from the slide member 34, and independent from the slide member 34. The slide member 36 is formed by way of bending a metal plate into a predetermined shape, and the slide member 36 includes two planar sections 36a and 36b that are individually perpendicular to a front-rear direction. The planar section 36b is placed at a left side position in relation to the planar section 36a, the left side position being at a front side in relation to the planar section 36a. A part of a left end of the planar section 36a and a part of a right end of the planar section 36b are connected with each other by use of a planar sloped section 36c that is sloped in relation to a right-left direction in a view from a vertical direction. The slide member 36 is placed at a front side in relation to the slide member 34.

At an upper end side of the planar section 36a, there is formed a slide groove 36d through which the guide pin 44 is inserted. The slide groove 36d is linearly formed from the left end of the planar section 36a toward a right side, and formed so as to completely pass through the planar section 36a in the front-rear direction. The guide pin 44 is capable of relative movement in relation to the slide member 36, along the slide groove 36d in the right-left direction. Moreover, the slide member 36 vertically slides while being pushed by the guide pin 44 inserted through the slide groove 36d. In this way, the other end side of the lever member 35, to which the guide pin 44 is fixed, is engaged with the slide member 36. Meanwhile, as described above, the shaft part llb of the thumb-turn 11 engages with the one end side of the lever member 35. In other words, the thumb-turn 11 and the slide member 36 are connected with each other by the intermediary of the lever member 35.

At a right end side in the planar section 36a, there is formed an elongated guide hole 36e being vertically elongated. The guide hole 36e is so formed as to completely pass through the slide member 36 in a front-rear direction. Through the guide hole 36e, the guide pin 38 is inserted. The slide member 36 vertically slides, while being guided by the guide pin 38 inserted through the guide hole 36e.

At a right end in the planar section 36a, there is formed a planar bent part 36f that is bent toward a rear side. The bent part 36f is formed so as to be planar and perpendicular to a right-left direction. Moreover, the bent part 36f is formed at a right-hand side of the guide hole 36e. The bent part 36f is placed at a right side in relation to the bent part 34h of the slide member 34, and a root part of the bent part 36f (a border between the planar section 36a and the bent part 36f) is placed above the protrusion 34j of the slide member 34. At a time when the slide member 34 and the slide member 36 are at their upper-limit positions, a lower end of the root part of the bent part 36f is placed above the protrusion 34j, while being in a situation of having a small space toward an upper end surface of the protrusion 34j.

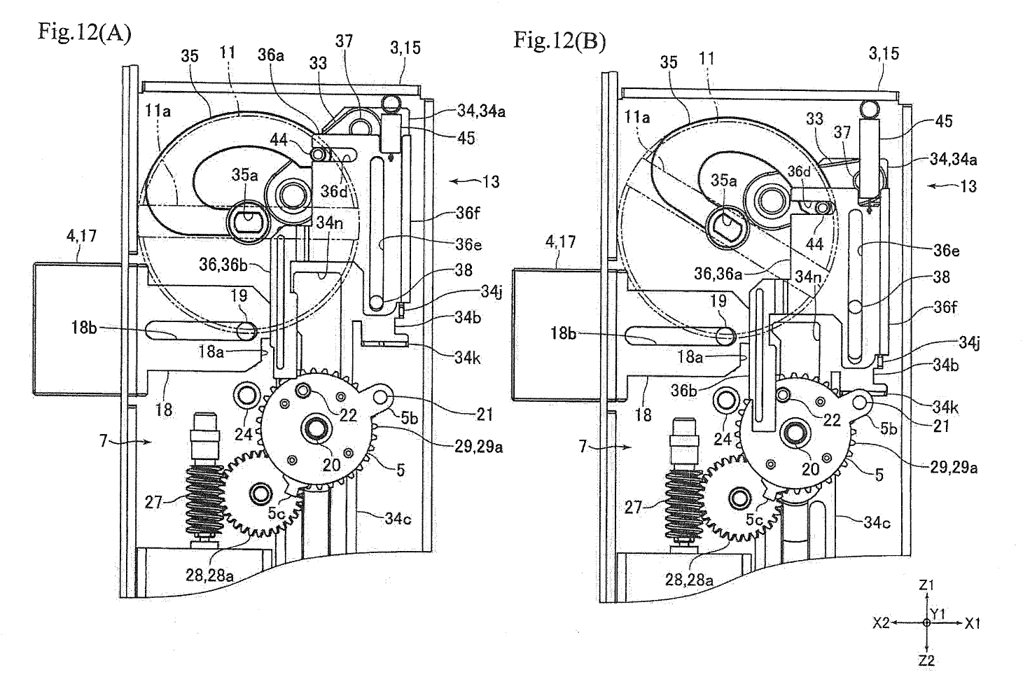

To an upper end side of the planar section 36a, one end of a tension coil spring 45 is fixed. Meanwhile, the other end of the tension coil spring 45 is fixed to a spring catch part 16c shaped at an upper end of the installation plate 16 (refer to FIG. 1 and so on). The tension coil spring 45 biases the slide member 36 upward. At a time when the slide member 36, biased owing to a biasing force of the tension coil spring 45, is placed at the upper-limit position, the thumb-turn 11 is located at an original position illustrated with a two-dotted dashed line in FIG. 12(A). The tension coil spring 45 of the present embodiment is a second biasing member for biasing the slide member 36 in order to return the thumb-turn 11 to the original position predetermined. Incidentally, the slide member 36 may be biased by any spring element other than the tension coil spring 45.

The planar section 36b is so formed as to be almost like a rectangular-shaped planar part being vertically elongated. A lower end of the planar section 36b protrudes toward a lower side in relation to a lower end of the planar section 36a. The planar section 36b is placed at a front side in relation to the dead bolt moving element 5. Moreover, the planar section 36b is placed at a left-hand side in relation to the fixing shaft 20.

In a situation where the slide member 36 is located at an upper-limit position, and the dead bolt moving element 5 is placed at a standby position of a locked side, as shown in FIG. 11(A); the planar section 36b is placed above the restriction pin 22. Therefore, as far as the dead bolt moving element 5 is placed at the standby position of the locked side, the slide member 36 is able to move downward until the lower end of the planar section 36b makes contact with the restriction pin 22, as shown in FIG. 11(B). Since then, the slide member 36 does not move downward any more. In other words, if the thumb-turn 11 is turned (specifically to describe, being turned in a clockwise direction) in a situation where the dead bolt moving element 5 is at the standby position of the locked side, the thumb-turn 11 turns until the lower end of the planar section 36b makes contact with the restriction pin 22. Then, if once the lower end of the planar section 36b makes contact with the restriction pin 22, the thumb-turn 11 does not turn any more since then.

When the slide member 36 moves downward until the lower end of the planar section 36b makes contact with the restriction pin 22, the protrusion 34j of the slide member 34 is pushed by the root part of the bent part 36f so that the slide member 34 also moves downward. In other words, if the thumb-turn 11 is operated (specifically to describe, being turned in a clockwise direction), the slide member 36 moves the slide member 34 downward. Until the lower end of the planar section 36b makes contact with the restriction pin 22; the slide member 34 does not move downward even though the slide member 36 moves downward, before the bent part 34k of the slide member 34 makes contact with the guide pin 21 of the dead bolt moving element 5, as shown in FIG. 11(B).

Namely, in a situation where the dead bolt moving element 5 is placed at the standby position of the locked side, a working range of the thumb-turn 11 is restricted by use of the planar section 36b and the restriction pin 22. Then, even with a turn of the thumb-turn 11 within the working range restricted, the dead bolt moving element 5 does not rotate. Moreover, since the dead bolt moving element 5 does not rotate, the dead bolt 4 does not move. Incidentally, a clearance may be formed between the lower end of the root part of the bent part 36f, at a time of having the slide member 34 and the slide member 36 at their upper-limit positions, and the upper end surface of the protrusion 34j; in such a way that the slide member 34 does not move downward, when the slide member 36 is moved downward, by way of turning the thumb-turn 11 in a situation where the dead bolt moving element 5 is placed at the standby position of the locked side, until the lower end of the planar section 36b makes contact with the restriction pin 22.

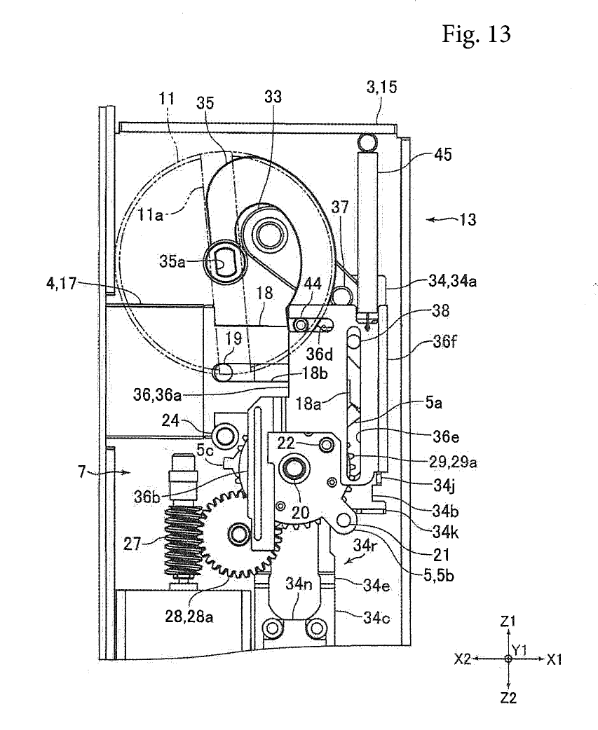

In the meantime, if the dead bolt moving element 5 rotates from the standby position of the locked side to the unlocking start position, the restriction pin 22 is located at a right-hand side in relation to the planar section 36b, as shown in FIG. 12(A). Therefore, at a time when the dead bolt moving element 5 is located at the unlocking start position, the slide member 36 is able to move downward together with the slide member 34, until the bent part 34k makes contact with the guide pin 21 so that the dead bolt moving element 5 moves to the standby position at the unlocked side, as shown in FIG. 12(B) and FIG. 13. In other words, at the time when the dead bolt moving element 5 is located at the unlocking start position; by way of turning the thumb-turn 11 in a clockwise direction, the dead bolt moving element 5 can be moved from the unlocking start position to the standby position at the unlocked side in order to move the dead bolt 4 to the unlocked position.

According to the present embodiment, if there is caused a displacement in a relative position between a strike hole formed in a door frame (not illustrated) to which the door 2 is fit so as to be openable, and the dead bolt 4 at a locked position, for example, owing to an effect of a change across the ages and the like, so that a friction resistance between the strike hole and the dead bolt 4 becomes great and the dead bolt 4 at the locked position cannot be moved even though the motor 6 drives, it is possible to move the dead bolt 4 to the unlocked position by way of turning the thumb-turn 11 from an outdoor side.

In other words, even if the dead bolt 4 at the locked position cannot be moved by power of the motor 6, the dead bolt moving element 5 can be rotated from the standby position of the locked side to the unlocking start position by power of the motor 6, since the first arm part 5a does not contact with the right side surface of the concave part 18a of the dead bolt 4 within an interval from the standby position of the locked side to the unlocking start position. Moreover, since the dead bolt moving element 5 can be rotated from the standby position of the locked side to the unlocking start position by the power of the motor 6, the dead bolt 4 can externally be moved to the unlocked position, by way of rotating the thumb-turn 11 from the outdoor side, after rotating the dead bolt moving element 5 to the unlocking start position by the power of the motor 6.

In this way, according to the present embodiment; at a time when the thumb-turn 11 is operated in the situation where the dead bolt moving element 5 is placed at the standby position of the locked side, the planar section 36b of the slide member 36 and the restriction pin 22 contact with each other to restrict the working range of the thumb-turn 11, in order to make the dead bolt 4 immobile. Meanwhile, in a situation where the dead bolt moving element 5 is placed at the unlocking start position, a restriction on the working range of the thumb-turn 11 is removed in such a way that the dead bolt 4 can move to the unlocking position; and then, if the thumb-turn 11, for which the restriction on the working range is removed, is operated (namely, if the thumb-turn 11 is turned) at a time when the dead bolt 4 is placed at the locked position, the slide member 34 engages with the guide pin 21 of the dead bolt moving element 5, in order to move the dead bolt moving element 5 from the unlocking start position to the unlocking finish position. Moreover, if the thumb-turn 11, for which the restriction on the working range is removed, is operated at a time when the dead bolt 4 is placed at the locked position, the cam part 34r engages with the flange part 29c to dissolve the engagement of the concave parts 29e and the engaging pins 23, before the slide member 34 engages with the guide pin 21 of the dead bolt moving element 5, in order to rotate the dead bolt moving element 5.

The slide member 34 in the present embodiment is a releasing member that moves the dead bolt moving element 5, at least from the unlocking start position to the unlocking finish position, while being engaged with the dead bolt moving element 5, wherein the slide member 34 is moved by a motion of the thumb-turn 11. In the meantime, the slide member 36 is a second restriction member to which the thumb-turn 11 is connected, wherein the second restriction member restricts a motion of the thumb-turn 11 by way of contacting the restriction pin 22 as a restriction member.

### (General Operation of the Electrical Lock)

In the case of the electrical lock 1 configured as described above, when an authentication by means of a predetermined authentication system finishes, usually the motor 6 gets activated and the dead bolt 4 placed at a locked position moves to an unlocked position. Then, after the door 2 opens/closes in succession to the movement of the dead bolt 4 to the unlocked position, or after a predetermined operation is carried out, the motor 6 gets activated and the dead bolt 4 placed at the unlocked position moves to the locked position. Meanwhile, if the thumb-turn 12 is turned from an indoor side, the dead bolt 4 placed at the locked position moves to the unlocked position. On the other hand, in the case where the dead bolt 4 placed at the locked position does not move even after the authentication by means of the predetermined authentication system finishes and the motor 6 gets activated, the dead bolt 4 placed at the locked position moves to the unlocked position, by way of turning the thumb-turn 11 from an outdoor side, since the dead bolt moving element 5 has already rotated to the unlocking start position by the power of the motor 6, as described above.

Incidentally, after a user turns the thumb-turn 12, while holding the finger grip 12a, for moving the dead bolt 4 to the unlocked position; even though the user does not return the thumb-turn 12 to the original position illustrated with a two-dotted dashed line in FIG. 6(A), the slide member 34 lifts to the upper-limit position owing to a biasing force of the compression coil spring 39 if once the user releases the finger grip 12a, and then the thumb-turn 12 returns to the original position. Meanwhile, after a user turns the thumb-turn 11, while holding the finger grip 11a, for moving the dead bolt 4 to the unlocked position; even though the user does not return the thumb-turn 11 to the original position illustrated with a two-dotted dashed line in FIG. 12(A), the slide member 36 lifts to the upper-limit position owing to a biasing force of the tension coil spring 45 if once the user releases the finger grip 11a, and then the thumb-turn 11 returns to the original position. Furthermore, at the time, the slide member 34 lifts to the upper-limit position owing to the biasing force of the compression coil spring 39.

### (Primary Advantageous Effect of the Present Embodiment)

As explained above, in the present embodiment, while the dead bolt moving element 5 moves the dead bolt 4 from the locked position to the unlocked position by use of the power of the motor 6, the dead bolt moving element 5 rotates in a sequential order; from the standby position at the locked side, shown in FIG. 5; by way of the unlocking start position where the dead bolt moving element 5 makes contact with the dead bolt 4, and a travel of the dead bolt 4 toward the unlocked position begins; by way of the unlocking finish position where the dead bolt 4 arrives at the unlocked position; to the standby position at the unlocked side, shown in FIG. 3(A). Moreover, in the present embodiment, at the time when the dead bolt moving element 5 is at the standby position of the locked side, the working range of the thumb-turn 11 is restricted by use of the planar section 36b and the restriction pin 22. Then, even with a turn of the thumb-turn 11 within the working range restricted, the dead bolt moving element 5 does not rotate, and accordingly the dead bolt 4 does not move. Therefore, according to the present embodiment, even though the thumb-turn 11 is located at the outdoor side, turning the thumb-turn 11 cannot move the dead bolt 4 placed at the locked position, unless an authentication by means of the authentication system finishes and the motor 6 gets activated. Accordingly, the electrical lock 1 of the present embodiment plays a role of a lock, even if the thumb-turn 11 is located at the outdoor side instead of a cylinder.

Moreover, according to the present embodiment; even in a situation where the dead bolt 4 placed at the locked position cannot be moved by the power of the motor 6 after an authentication finished by means of the authentication system, the dead bolt moving element 5 can still be moved from the standby position at the locked side to the unlocking start position by the power of the motor 6. Therefore, after moving the dead bolt moving element 5 to the unlocking start position by the power of the motor 6, turning the thumb-turn 11 from an outdoor side can move the dead bolt 4 to the unlocked position.

In this way, the electrical lock 1 of the present embodiment plays a role of a lock, even if the thumb-turn 11 is located at the outdoor side instead of a cylinder. In the meantime, according to the present embodiment, even in a situation where the dead bolt 4 placed at the locked position cannot be moved by the power of the motor 6, the dead bolt 4 can be moved to the unlocked position by turning the thumb-turn 11 located at the outdoor side. Therefore, according to the present embodiment, while it is possible to externally move the dead bolt 4 that cannot be moved by the power of the motor 6, a manufacturing cost for the electrical lock 1 can be reduced.

In the present embodiment, the slide member 34 is formed separately from the slide member 36, and independent from the slide member 36. Therefore, according to the present embodiment; even without rotating the dead bolt moving element 5 from the standby position at the locked side to the unlocking start position by the power of the motor 6, the dead bolt 4 placed at the locked position can be moved to the unlocked position, as described above, by way of turning the thumb-turn 12. Accordingly, in the present embodiment, it becomes possible to easily move the dead bolt 4 placed at the locked position by use of the thumb-turn 12 located at the indoor side.

In the present embodiment, the slide member 34 is formed separately from the dead bolt moving element 5, and independent from the dead bolt moving element 5. Moreover, in the present embodiment, the slide member 34 is lifted up so as to become distant from the dead bolt moving element 5, with a biasing force by the compression coil spring 39; and the slide member 36 is also lifted up with a biasing force by the tension coil spring 45. Therefore, in the present embodiment, at a time when the dead bolt moving element 5 is rotated by power of the motor 6, the thumb-turn 11, the thumb-turn 12, the lever member 33, the lever member 35, the slide member 34, and the slide member 36 do not move (refer to FIG. 3(A) through FIG. 5). Accordingly, in the present embodiment; at a time of moving the dead bolt 4 between the unlocked position and the locked position by the power of the motor 6, a load of the motor 6 can be reduced.

In the present embodiment, by way of turning the thumb-turn 12, or by way of turning the thumb-turn 11 in a situation where the restriction on the working range of the thumb-turn 11 is removed; the_slide member 34 moves downward so that the engaging pins 23 are disengaged from the concave parts 29e of the gear component 29, and subsequently the bent part 34k makes contact with the guide pin 21 in order to rotate the dead bolt moving element 5. Namely, in the present embodiment, the dead bolt moving element 5 and the power transmission mechanism 7 get separated, before the dead bolt moving element 5 rotates. Therefore, in the present embodiment, even though the power transmission mechanism 7 includes a worm gear set configured with the worm gear 27 and the herical gear 28a, it becomes possible to rotate the dead bolt moving element 5 by way of turning the thumb-turn 11 and the thumb-turn 12, in order to move the dead bolt 4 from the locked position to the unlocked position.

### Other Embodiments

Described above is an example of an embodiment according to the present invention. Incidentally, the present invention is not limited to the above embodiment and various variations and modifications may be made without changing the concept of the present invention.

Although, in the embodiment described above, the restriction pin 22 is fixed to the dead bolt moving element 5, a restriction member equivalent to the restriction pin 22 may be formed together with the dead bolt moving element 5 as a single component. Moreover, in the embodiment described above, although the engaging pins 23 are fixed to the dead bolt moving element 5, an engaging member equivalent to the engaging pins 23 may be formed together with the dead bolt moving element 5 as a single component. Furthermore, in the embodiment described above; although the engaging pins 23 are fixed to the dead bolt moving element 5, and the concave parts 29e with which the engaging pins 23 engage are formed in the gear component 29; an engaging pin may be formed in, or fixed to the gear component 29, while a concave part with which the engaging pin engages is formed in the dead bolt moving element 5.

Although, in the embodiment described above, the cam part 34r is formed in the slide member 34, the cam part 34r may not be formed in the slide member 34 if the power transmission mechanism 7 includes no worm gear set. Moreover, although in the embodiment described above, the slide member 34 is independent from the slide member 36, the slide member 34 may be connected to the slide member 36. In this case, the manual unlocking mechanism 13 may not be provided with the lever member 33. In the case where the manual unlocking mechanism 13 is not provided with the lever member 33, for example, the shaft part 12b of the thumb-turn 12 engages, from a rear side, with the one end side of the lever member 35. Furthermore, although in the embodiment described above, the slide member 34 is independent from the dead bolt moving element 5, the slide member 34 may be connected to the dead bolt moving element 5.

Although, in the embodiment described above; at a time when the slide member 34 and the slide member 36 are their upper-limit positions, a lower end of the root part of the bent part 36f is placed above the protrusion 34j, while being in a situation of having a small space toward an upper end surface of the protrusion 34j; the lower end of the root part of the bent part 36f may be in contact with the upper end surface of the protrusion 34j, at the time when the slide member 34 and the slide member 36 are their upper-limit positions. In this case, owing to the biasing force of the compression coil spring 39, the slide member 36 can be moved to the upper-limit position and the thumb-turn 11 can be returned to the original position, and therefore the tension coil spring 45 is not needed.

Although, in the embodiment described above, the dead bolt moving element 5 is supported by the main body case 3, in such a way as to be rotatable, and rotated by the power of the motor 6; the dead bolt moving element 5 may be supported by the main body case 3, in such a way as to be slidable, and slid linearly by the power of the motor 6. Moreover, although in the embodiment described above, a drive source for moving the dead bolt moving element 5 is the motor 6; the drive source for moving the dead bolt moving element 5 may be, for example, a solenoid. Furthermore, although in the embodiment described above, the thumb-turn 11 is placed at the outdoor side of the door 2; a manual-handling component instead of the thumb-turn 11, such as a handle and the like, may be placed at the outdoor side of the door 2.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An electrical lock being installed on a door, the electrical lock comprising:
a main body case;
a dead bolt being movable between a locked position where the dead bolt protrudes out of the main body case, and an unlocked position where the dead bolt is housed in the main body case;
a dead bolt moving element that is engaged with the dead bolt, and is structured to move the dead bolt;
a drive source structured to move the dead bolt moving element;
a power transmission mechanism structured to transmit power of the drive source to the dead bolt moving element;
a manual-handling component, which is placed at an outdoor side of the door, structured to manually move the dead bolt, being at the locked position, to the unlocked position;
a manual unlocking mechanism to which the manual-handling component is connected; and
a restriction member structured to restrict a motion of the manual-handling component, the restriction member being formed in, or fixed to the dead bolt moving element;
wherein, in a situation where the dead bolt moving element moves the dead bolt from the locked position to the unlocked position by use of the power of the drive source, the dead bolt moving element moves in a sequential order; from a standby position; by way of an unlocking start position where the dead bolt moving element makes contact with the dead bolt, and a travel of the dead bolt toward the unlocked position begins; to an unlocking finish position where the dead bolt arrives at the unlocked position; and
the manual unlocking mechanism comprises:
a second restriction member, to which the manual-handling component is connected, structured to restrict a motion of the manual-handling component, by way of contacting the restriction member; and
a releasing member structured to move the dead bolt moving element, from the unlocking start position to the unlocking finish position, while being engaged with the dead bolt moving element, and the releasing member being moved by a motion of the manual-handling component; and
at a time when the manual-handling component is operated in the situation where the dead bolt moving element is placed at the standby position, the restriction member and the second restriction member contact with each other to restrict the working range of the manual-handling component, in order to make the dead bolt immobile; and
in a situation where the dead bolt moving element is placed at the unlocking start position, a restriction on the working range of the manual-handling component is removed in such a way that the dead bolt can move to the unlocking position.

2. The electrical lock according to claim 1;
wherein, the electrical lock comprises a second manual-handling component placed at an indoor side of the door, structured manually move the dead bolt placed at the locked position to the unlocked position;
the second manual-handling component is connected to the releasing member; and
the second restriction member is formed separately from the releasing member, and independent from the releasing member, and the second restriction member is structured to move the releasing member, by way of operating the manual-handling component.

3. The electrical lock according to claim 2;
wherein, the manual unlocking mechanism comprises:
a first lever member in which a first engaging hole is formed at one end, wherein a part of the manual-handling component being inserted into, and engaged with the first engaging hole, the first lever member being supported by the main body case so as to be rotatable, and rotating in connection with a rotating motion of the manual-handling component; and
a second lever member in which a second engaging hole is formed at one end, wherein a part of the second manual-handling component being inserted into, and engaged with the second engaging hole, the second lever member being supported by the main body case so as to be rotatable, and rotating in connection with a rotating motion of the second manual-handling component; and
the other end side of the first lever member is engaged with the second restriction member, and the manual-handling component and the second restriction member are connected with each other by the intermediary of the first lever member; and
the other end side of the second lever member is engaged with the releasing member, and the second manual-handling component and the releasing member are connected with each other by the intermediary of the second lever member.

4. The electrical lock according to claim 2;
wherein, the manual unlocking mechanism comprises:
a first biasing member structured to bias the releasing member in order to return the second manual-handling component to an original position predetermined; and
a second biasing member structured to bias the second restriction member in order to return the manual-handling component to an original position predetermined; and
the releasing member is formed separately from the dead bolt moving element, and independent from the dead bolt moving element; and
by way of operating the manual-handling component in a situation where the restriction on the working range is removed, or by way of operating the second manual-handling component, the releasing member is structured to engage with the dead bolt moving element so as to move the dead bolt moving element from the unlocking start position to the unlocking finish position.

5. The electrical lock according to claim 4;
wherein, the dead bolt moving element is rotatably supported by the main body case;
the power transmission mechanism is comprises a gear component that is coaxially located with the dead bolt moving element, and placed so as to overlap with the dead bolt moving element, in a rotating shaft direction of the dead bolt moving element; and a gear biasing component structured to bias the gear component;
a first engaging part is formed in, or fixed to, the dead bolt moving element, in such a way as to be engaged with the gear component;
a second engaging part is formed in, or fixed to, the gear component in such a way as to be engaged with the first engaging part;
the gear biasing component is structured to bias the gear component in such a way that the first engaging part and the second engaging part are engaged with one another so that the dead bolt moving element and the gear component rotate together;
the releasing member comprises a cam part structured to dissolve engagement of the first engaging part and the second engaging part;
the gear component is provided with a cam follower part for engagement of the cam part; and
at a time of operating the manual-handling component in a situation where the restriction on the working range is removed, or at a time of operating the second manual-handling component, the cam part is structured to engage with the cam follower part so as to dissolve the engagement of the first engaging part and the second engaging part, before the releasing member is engaged with the dead bolt moving element so as to rotate the dead bolt moving element.
